(19) United States
(12) Patent Application Publication
(10) Pub. No.: US 2019/0070685 A1
(43) Pub. Date: Mar. 7, 2019

(54) SYSTEM FOR MANUFACTURING COMPONENT

(71) Applicant: Caterpillar Inc., Deerfield, IL (US)

(72) Inventors: Thierry Marchione, Heber City, UT (US); Bradley Phillip Graham, Lake Tapps, WA (US)

(73) Assignee: Caterpillar Inc., Deerfield, IL (US)

(21) Appl. No.: 16/172,929

(22) Filed: Oct. 29, 2018

(51) Int. Cl. B23K 9/04; B23K 9/12; B23K 9/10; B23K 9/095

(52) U.S. Cl. CPC B23K 9/042; B23K 9/126; B33Y 10/00; B23K 9/1006; B23K 9/0956; B23K 9/124

(57) ABSTRACT

A system for manufacturing a component includes a power supply unit adapted to generate welding power. The system also includes a welding system. The welding system includes a welding torch having a welding wire. The welding wire is movable in an axial direction and a radial direction with respect to a central axis of the welding torch for depositing material from the welding wire to manufacture the component. The welding system also includes a motion control assembly. The motion control assembly is adapted to move the welding wire in the radial direction. The system further includes a control unit configured to transmit control signals to the welding system for controlling at least one of a rotation speed of the welding wire, a diameter of rotation of the welding wire, a direction of rotation of the welding wire, and a iced rate of the welding wire.

### TECHNICAL FIELD

The present disclosure relates to a system the manufacturing a component.

### BACKGROUND

Conventionally, Three Dimensional (3D) components are manufactured using welding techniques, such as wire arc technology, Cold Metal Transfer (CMT), or pulse mode arcing. During a manufacturing process of the component, such welding techniques do not provide a stable arc between a welding wire and the component. Due to instability of the arc, it becomes difficult to control the manufacturing process. More particularly, the instability of the arc makes it difficult to control and/or reduce heat input during the manufacturing process. Some methods are used to weave the arc with a robotic motion but such methods lead to an increase in the heat input and also cause dilution or distortion of the component, which is not desirable.

U.S. Pat. No. 9,937,580 describes a method and system to manufacture workpieces employing a high intensity energy source to create a puddle and at least one resistively heated wire which is heated to at or near its melting temperature and deposited into the puddle as droplets.

### SUMMARY OF THE DISCLOSURE

In one aspect of the present disclosure, a system for manufacturing a component is provided. The system includes a power supply unit adapted to generate welding power. The system also includes a welding system adapted to receive the welding power from the power supply unit. The welding system includes a welding torch having a welding wire. The welding wire is movable in an axial direction and a radial direction with respect to a central axis of the welding torch for depositing material from the welding wire to manufacture the component. The welding system also includes a motion control assembly associated with the welding torch. The motion control assembly is adapted to move the welding wire in the radial direction. The system further includes a control unit communicably coupled with the welding system. The control unit is configured to transmit control signals to the welding system for controlling at least one of a rotation speed of the welding wire, a diameter of rotation of the welding wire, a direction of rotation of the welding wire, and a feed rate of the welding wire during the manufacturing of the component.

Other features and aspects of this disclosure will be apparent from the following description and the accompanying drawings.

### BRIEF DESCRIPTION OF THE DRAWINGS

FIG. 1 is a block diagram of a system for manufacturing a component, according to various concepts of the present disclosure; and

FIG. 2 is a schematic view illustrating a welding torch associated with the system of FIG. 1 and the component, according to various concepts of the present disclosure.

### DETAILED DESCRIPTION

Wherever possible, the same reference numbers will be used throughout the drawings to refer to the same or the like parts. Also, corresponding or similar reference numbers will be used throughout the drawings to refer to the same or corresponding parts.

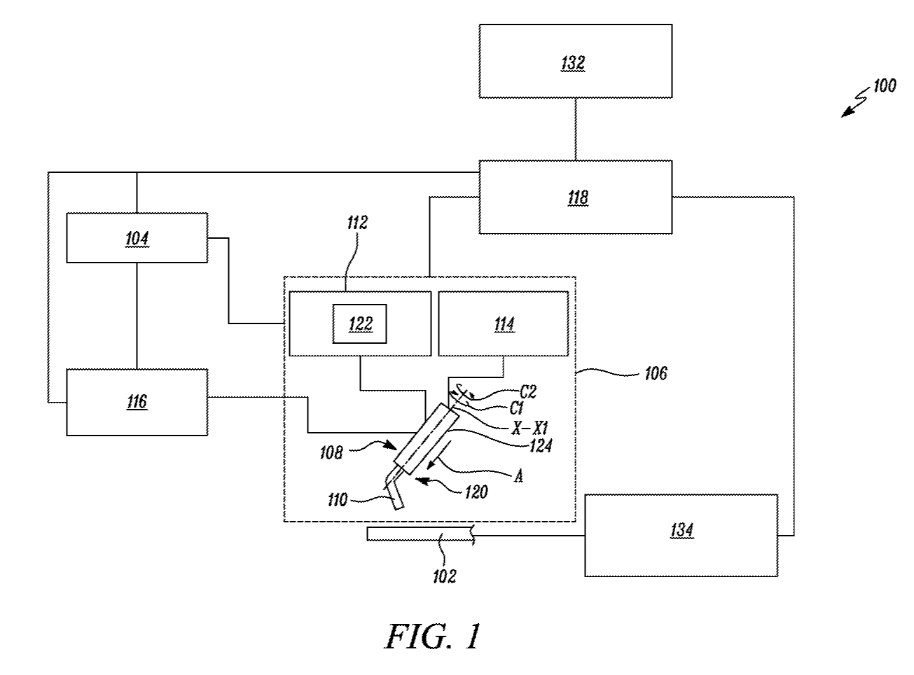

FIG. 1 illustrates a block diagram of an exemplary system 100 for manufacturing a component 102. More particularly, the system 100 is used for additive manufacturing of the component 102. The component 102 may include any Three-Dimensional (3D) component that may be associated with an industry, including but not limited to, household appliances, mining, construction, farming, transportation, or any other industry known in the art. Further, the component 102 may include any shape and size, based on application requirements.

The system 100 includes a power supply unit 104 that generates welding power. The power supply unit 104 may embody a power grid, a generator, an engine driven power pack, a battery pack, and the like. Further, the system 100 includes a welding system 106. In the illustrated embodiment, the welding system 106 is embodied as a rotating arc welding system. The welding system 106 receives welding power from the power supply unit 104. The welding system 106 includes a welding torch 108 having a welding wire 110, a wire feeder 112, and a motion control assembly 114. It should be noted that the welding wire 110 may include a metal cored welding wire, a solid wire, or a flux cored wire, without any limitations.

In the illustrated example, the welding system 106 is automated, and the welding torch 108 is secured to a motion system 116 that is programmed to position the welding torch 108 at desired locations with respect to the component 102 during a manufacturing process of the component 102. More particularly, the motion system 116 orients the welding torch 108 and advances the welding torch 108 along a predefined tool-path where a layer of material is to be deposited to manufacture the component 102. The motion system 116 may be in communication with the power supply unit 104 to receive power supply for movement of the motion system 116. The motion system 116 may include stepper motors or servo motors to move the welding torch 108. In an example, the motion system 116 may include a five-axis motion system. Further, the motion system 116 may embody a robot. However, in another example, the welding system 106 may be designed for manual operation, without limiting the scope of the present disclosure.

The system 100 also includes a control unit 118. The control unit 118 is in communication with the welding system 106, the motion system 116, and the power supply unit 104. The control unit 118 transmits control signals from the welding system 106, the motion system 116, and the power supply unit 104 to control the manufacturing process of the component 102. Further, the control unit 118 may store a 3D model of the component 102 that is to be manufactured using the system 100 in the form of a Computer-Aided Design (CAD) file or an Additive Manufacturing File (AMF). The control unit 118 may further include a software to process an STL file (stereolithography file format) that mathematically slices and orients the 3D model for the manufacturing process. Further, the control unit 118 may control the motion system 116 in order to move the motion system 116 in multiple directions by a numerically controlled mechanism or a computer numerically controlled mechanism. The motion system 116 may follow the predefined tool-path that is controlled by a Computer-Aided Manufacturing (CAM) software package to manufacture the component 102.

The control unit 118 may be electrically connected to the welding system 106 and the motion system 116 via wired connections, wireless connections, or a combination thereof. The control unit 118 may include a processor, a memory, Input/Output (I/O) interfaces, communication interfaces, and other components. The processor may execute various instructions stored in the memory for carrying out various operations of the control unit 118. The control unit 118 may receive and transmit signals and data through the I/O interfaces and the communication interfaces. In further embodiments, the control unit 118 may include microcontrollers, Application-Specific Integrated Circuits (ASICs), Field Programmable Gate Arrays (FPGAs), and so forth.

Further, the wire feeder 112 of the welding system 106 may be externally disposed with respect to the welding torch 108. The wire feeder 112 is coupled to the welding torch 108, the power supply unit 104, and the control unit 118. The wire feeder 112 supplies the welding wire 110 to the welding torch 108. The wire feeder 112 moves the welding wire 110 in an axial direction “A” with respect to a central axis “X-X1” of the welding torch 108 for depositing material from the welding wire 110 to manufacture the component 102. The axial direction “A” is defined as a direction extending parallel to the central axis “X-X1” towards an end portion 120 of the welding torch 108.

In an example, the wire feeder 112 may include a control module 122 in communication with the control unit 118. The control module 122 may regulate a feed rate of the welding wire 110 from a spool (not shown) based on control signals received from the control unit 118. More particularly, the wire feeder 112 may receive control signals pertaining to the feed rate of the welding wire 110 from the control unit 118. It should be noted that the feed rate may vary as per system requirements. In one example, the feed rate may be approximately equal to 15 pounds per hour, without any limitations. The welding wire 110 may be advanced by a drive assembly (not shown) of the wire feeder 112. The drive assembly is in communication with the control module 122 and receives signals from the control module 122. The drive assembly may include, for example, an electric motor that is controlled by the control unit 118. It should be noted that in some examples the system 100 may eliminate the control module 122 and the functions of the control module 122 may be performed by the control unit 118, without any limitations.

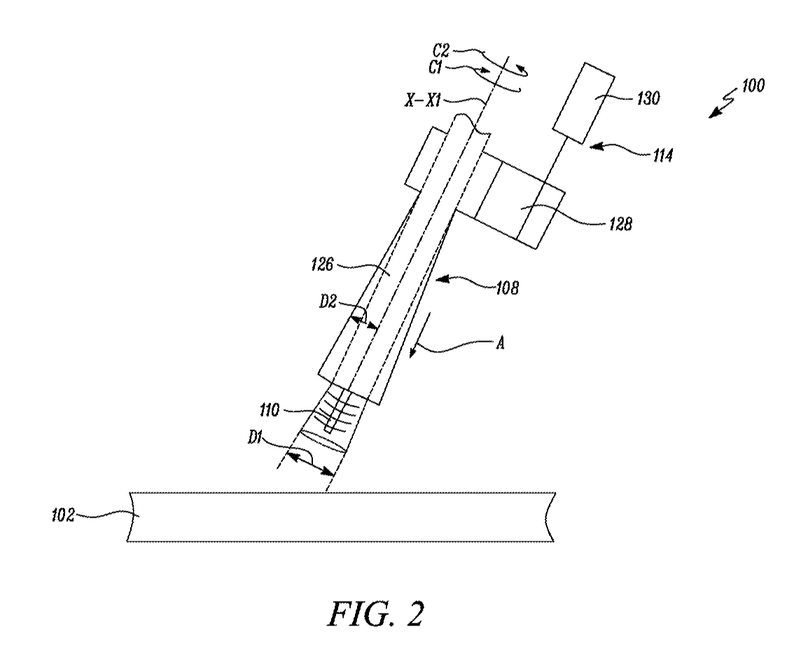

Further, the welding torch 108 defines the central axis “X-X1” and includes, among other components, a barrel 124. The welding torch 108 may include a straight barrel or may include a barrel having a bend, without any limitations. Referring to FIG. 2, the welding torch also includes a contact element 126. The welding wire 110 is received within the contact element 126 such that a rotation of the contact element 126 causes the welding wire 110 to move in a radial direction “C1”, “C2” with respect to the central axis “X-X1” of the welding torch 108. The radial direction “C1”, “C2” may include a rotation of the welding wire 110 in a clockwise direction “C1” or an anti-clockwise direction “C2” about the central axis “X-X1”. It should be noted that the radial direction “C1” is hereinafter interchangeably referred to as the clockwise direction “C1” and the radial direction “C2” is hereinafter interchangeably referred to as the anti-clockwise direction “C2”. It should be noted that the welding wire 110 may move in the radial direction “C1”, “C2” while following a desired pattern. In some examples, the desired pattern may be a symmetric pattern or an asymmetric pattern. The desired pattern may include, for example, a circular pattern, an elliptical pattern, and the like.

The welding system 106 also includes the motion control assembly 114. In an example, the motion control assembly 114 is disposed within the welding torch 108. The motion control assembly 114 is in communication with the welding wire 110, the power supply unit 104 (see FIG. 1), and the control unit 118 (see FIG. 1). The motion control assembly 114 moves the welding wire 110 in the radial direction “C1”, “C2” via the contact element 126. The motion control assembly 114 includes a cam 128 that is rotated by a motor 130 to move the welding wire 110. However, the motion control assembly 114 may include other components for moving the welding wire 110. In some examples, the motion control assembly 114 may also move the welding wire 110 in the axial direction “A” based on a movement of the contact element 126 parallel to the central axis “X-X1”. The motion control assembly 114 may accordingly include components that allow the movement of the contact element 126 along the axial direction “A”.

The motion control assembly 114 receives control signals from the control unit 118 regarding the direction “C1”, “C2” of the rotation of the welding wire 110. Based on the control signals received from the control unit 118, the motion control assembly 114 causes the welding wire 110 to rotate in the clockwise or anti-clockwise directions “C1”, “C2” with respect to the central axis “X-X1”. More particularly, the motor 130 of the motion control assembly 114 may receive control signals from the control unit 118 to rotate in a clockwise direction or an anti-clockwise direction. A rotation of the motor 130 in the clockwise direction causes the contact element 126 and the welding wire 110 to rotate in the anti-clockwise direction “C2”. Further, a rotation of the motor 130 in the anti-clockwise direction causes the contact element 126 and the welding wire 110 to rotate in the clockwise direction “C1”.

The motion control assembly 114 also receives control signals from the control unit 118 to vary a diameter of rotation “D1” of the welding wire 110. More particularly, the motion control assembly 114 may cause the contact element 126, and therefore, the welding wire 110 to move by a predetermined radius “D2” from the central axis “X-X1”, during the manufacturing process. Such a movement of the welding wire 110 during the rotation of the welding wire 110 allows variation in the diameter of rotation “D1” of the welding wire 110. By controlling the diameter of rotation “D1” of the welding wire 110, a size of the component 102 to be manufactured can be controlled. For example, a higher diameter of rotation “D1” may be used when the component 102 has a larger size, whereas a smaller diameter of rotation “D1” may be used when the component 102 has a smaller size.

Additionally, the motion control assembly 114 also receives control signals from the control unit 118 to regulate a speed of rotation of the welding wire 110. Based on the control signals received from the control unit 118, the motion control assembly 114 causes the welding wire 110 to rotate at a predefined speed. More particularly, the motor 130 of the motion control assembly 114 may receive control signals from the control unit 118 to rotate at a speed which allows rotation of the welding wire 110 at the predefined speed. Referring now to FIG. 1, in some embodiments, the control unit 118 also controls the welding power supplied to the welding wire 110. In such an example, the control unit 118 may control the power supply unit 104 to adjust the welding power provided to the welding wire 110. Further, the system 100 may include an input device 132 that is in communication with the control unit 118. An operator of the system 100 may select parameters, such as the speed of rotation, direction “C1”, “C2” of the rotation, and/or diameter of rotation “D1” of the welding wire 110, the feed rate of the welding wire 110, the welding power provided to the welding wire 110, and the like via the input device 132.

For manufacturing of the component 102, the welding torch 108 with the welding wire 110 is positioned in close vicinity to a substrate (not shown). The control unit 118 sends control signals to the contact element 126 to rotate the welding wire 110. Further, the welding power supplied to the welding wire 110 causes an arc to be established between the welding wire 110 and the substrate. The arc causes material of the welding wire 110 to melt and a molten metal pool is formed on the substrate as the welding wire 110 moves in the radial direction “C1”, “C2”. The molten metal pool of the material solidifies on the substrate and as the welding wire 110 is advanced along the predefined tool-path by the motion system 116, a first layer of the component 102 is formed. It should be noted that the motion system 116 is moved at a desired travel speed that is controlled by the control unit 118. Further, the welding system 106 creates a second layer of the component 102 and so forth based on the movement of the motion system 116 and the associated welding wire 110 such that the material from the welding wire 110 gets deposited and fuses with the previous layer thereby manufacturing the component 102. Also, while manufacturing some portions of the component 102, the control unit 118 may stop the movement of the welding wire 110 in the radial direction “C1”, “C2”, based on requirements. For example, while performing material deposition at cooler parts, the control unit 118 may send control signals to the contact element 126 to stop the movement of the welding wire 110 in the radial direction “C1”, “4”.

Additionally, the system 100 may include a temperature sensor 134 to measure a temperature of the molten metal pool that is created as the material from the welding wire 110 gets deposited on the component 102. The temperature sensor 134 may include a pyrometer or any other temperature sensor that detects the temperature of the molten metal pool. The temperature sensor 134 may communicate with the control unit 118 such that the control unit 118 receives measured values of the temperature of the molten metal pool from the temperature sensor 134. In such an example, the system 100 may receive and process the measured values of the temperature. If the measured value is lower or higher than a predefined limit, the control unit 118 may adjust one or more parameters so that the measured value of the temperature lies within predefined limits. It should be noted that the parameters may include any one of the speed of rotation, direction “C1”, “C2” of the rotation, and/or diameter of rotation “D1” of the welding wire 110, the feed rate of the welding wire 110, the welding power provided to the welding wire 110, and the like.

### INDUSTRIAL APPLICABILITY

The present disclosure relates to the system 100 for manufacturing the component 102. As discussed above, the welding system 106 is used to manufacture the component 102 based on the deposition of the material from the welding wire 110. The welding system 106 employs the rotatable welding wire 110 whose speed of rotation and the diameter of rotation “D1” can be controlled which in turn provides a stable arc during the manufacturing process. The stability of the arc provided by the welding system 106 allows improved control of the manufacturing process. Additionally, as the diameter of rotation “D1” of the welding wire 110 can be easily controlled, the welding system 106 allows manufacturing of a component having different sizes at different portions of the component. Further, the welding system 106 described herein also provides improved temperature management as the temperature of the molten metal pool can be easily controlled by varying the speed and/or diameter of rotation “D1” of the welding wire 110.

Further, the welding system 106 can be used to manufacture components of a large size with low dilution and low heat input. The welding system 106 also allows usage of high feed rates during the manufacturing of the component 102. It should also be noted that the component 102 manufactured by the system 100 includes lower distortions. Additionally, the welding system 106 can be easily associated with multi-axis motion systems to manufacture complex parts.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof.

1 A system for manufacturing a component, the system comprising:
a power supply unit adapted to generate welding power;
a welding system adapted to receive the welding power from the power supply unit, the welding system comprising:
a welding torch including a welding wire, the welding wire being movable in an axial direction and a radial direction with respect to a central axis of the welding torch for depositing material from the welding wire to manufacture the component; and
a motion control assembly associated with the welding torch, wherein the motion control assembly is adapted to move the welding wire in the radial direction; and
a control unit communicably coupled with the welding system, wherein the control unit is configured to transmit control signals to the welding system for controlling at least one of a rotation speed of the welding wire, a diameter of rotation of the welding wire, a direction of rotation of the welding wire, and a feed rate of the welding wire during the manufacturing of the component.
